(19) United States
(12) Patent Application Publication
(10) Pub. No.: US 2005/0050232 A1
(43) Pub. Date: Mar. 3, 2005

(54) Information processing apparatus, keyboard controller, and method of key input determination

(75) Inventor: Kazuhiro Yoshioka, Akishimia-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/860,008

(22) Filed: Jun. 4, 2004

(30) Foreign Application Priority Data
Aug. 29, 2003 (JP) 2003-307640

(51) Int. Cl. G06F 3/00

(52) U.S. Cl. 710/1

(57) ABSTRACT

A keyboard controller includes a monitored key specifying unit that accepts, through a command transmitted via a system bus, a specification as to which key on a keyboard is to be monitored for input, and a specified key monitoring unit that senses input of the specified key on the basis of the state of a plurality of signal lines from the keyboard and that stores the results of the monitoring in a register as key input information. A POST (initialization) processing unit of a BIOS notifies the monitored key specifying unit of the key for which the POST processing unit is to determine whether or not the key has been inputted. The POST processing unit requests the specified key monitoring unit to transfer the key input information stored in the register as required.

### CROSS-REFERENCE TO RELATED APPLICATIONS

This application is based upon and claims the benefit of priority from prior Japanese Patent Application No. 2003-307640, filed Aug. 29, 2003, the entire contents of which are incorporated herein by reference.

### BACKGROUND OF THE INVENTION

1. Field of the Invention

The present invention relates to an information processing apparatus that utilizes a keyboard as an input device, a keyboard controller suitably applied to the information processing apparatus, and a method of key input determination.

2. Description of the Related Art

In recent years, various types of personal computer such as a notebook type and a desktop type have become popular. Almost all these personal computers utilize a keyboard as an input device.

For example, more than one hundred keys are arranged on the keyboard in a matrix. A plurality of vertical signal lines and a plurality of horizontal signal lines are laid inside the keyboard also in a matrix in order to sense input of a key. A keyboard controller electrically connected to the keyboard senses the input of each key on the basis of the state of the signal lines. The keyboard controller thus generates a scan code corresponding to the input key.

A Basic Input/Output System (BIOS) acquires and converts the scan code generated by the keyboard controller into a key code. Then, software such as an operating system which is executed by a CPU provides the key code to an active application program or the like to execute various types of data processing on the code. In this connection, when solely input, some of what are called special keys do not cause the keyboard controller to generate any scan codes.

When a personal computer of this kind is powered on, the BIOS checks and initializes various devices, activates the operating system, and performs other operations. The BIOS includes a routine for updating environment settings for the computer. When a predetermined key input is carried out after the computer has been powered on and before the operating system is activated, the routine for updating the environment settings is called to provide a user with an interface used to make desired settings (refer to, for example, Jpn. UM Appln. KOKAI Publication No. 7-25416).

The BIOS comprises a routine called a keyboard interrupt service which converts a scan code acquired from the keyboard controller into a key code. If the keyboard interrupt service is active, a power-on self-test (POST) processing routine for initialization also provided in the BIOS receives the key code from the key code interrupt service to determine whether or not a predetermined key input has been provided. In other words, before the keyboard interrupt service is enabled, the POST process uses the scan code as acquired from the keyboard controller to determine whether or not the predetermined key input has been provided. That is, the POST process switches the method of key input determination when the keyboard interrupt service is enabled.

Here, it is assumed that for example, an operation of inputting a plurality of keys as one meaningful key is performed on the keyboard and that when this operation is performed, the method of key input determination executed by the POST process is switched. In this case, it is sufficiently possible that after some of the scan codes have been delivered to the POST process, the remaining scan codes are delivered to the keyboard interrupt service. In this case, the keyboard interrupt service may generate incorrect key codes.

Furthermore, the POST process communicates with the keyboard controller in order to initialize the keyboard and a mouse. In this case, the transmission of a response code from the keyboard controller to the BIOS is given priority over the transmission of scan codes associated with a key input. Accordingly, even if the user executes a predetermined key input while the keyboard and mouse are being initialized, the input may not be communicated to the BIOS depending on when the key is input. In this case, the key input is useless.

Moreover, to initialize the keyboard and mouse, the POST process transmits a command to the keyboard controller which permits it to communicate with the BIOS. On the other hand, upon receiving this command, the keyboard controller is enabled to store scan codes associated with a key input in its built-in register. Then, during the POST process, the keyboard controller transmits the command early enough to deal with a key input provided early after the power-on of the computer. Subsequently, the BIOS acquires the scan codes sequentially stored in the built-in register before the POST process reaches a step of determining whether or not the predetermined key input has been provided. The scan codes acquired by the BIOS are normally stored in a system memory of the computer as information used for key input determination, which is required data. That is, the keyboard and mouse are never initialized before the system memory is completely initialized and enabled. If the user provides the predetermined key input before the system memory is initialized, the input will be useless.

Recently, with the rapid development of performance of the CPU, peripheral devices, and the like, the time from the power-on of the computer system till the activation of the operating system has been sharply reduced. In this situation, it is a non-negligible problem in terms of convenience that there are many cases in which the predetermined key input is not accepted by the BIOS and becomes useless as previously described.

### BRIEF SUMMARY OF THE INVENTION

According to an embodiment of the present invention, an information processing apparatus having a keyboard, comprises a specifying unit configured to specify an arbitrary key of the keyboard as a key for which it is determined whether or not the key has been input, and a determining unit configured to determine, upon sensing a signal generated by operating the key specified by the specifying unit, that the specified key has been input.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the embodiments given below, serve to explain the principles of the invention.

FIG. 1 is a diagram showing a configuration for key input determination made by an information processing apparatus according to an embodiment of the present invention;

FIGS. 2A to 2C are conceptual drawings illustrating a method of key input determination executed by the information processing apparatus according this embodiment; and

FIG. 3 is a flowchart showing the flow of a POST (initialization) process for in the information processing apparatus according to this embodiment.

### DETAILED DESCRIPTION OF THE INVENTION

An embodiment of the present invention will be described below with reference to the drawings.

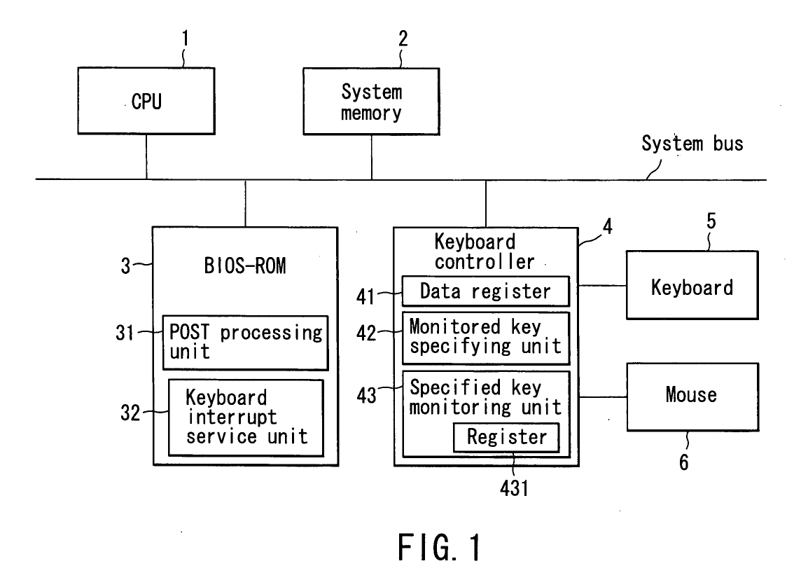

FIG. 1 is a diagram showing a configuration for key input determination made by an information processing apparatus according to the embodiment of the present invention.

This information processing apparatus is, for example, a notebook- or desktop-type personal computer. The information processing apparatus comprises a CPU 1, a system memory 2, a BIOS-ROM 3, and a keyboard controller 4 as shown in FIG. 1. These components are connected to a system bus laid in the computer. The components can thus communicate with one another via the system bus. A keyboard 5 and a mouse 6 are connected to the keyboard controller 4. The keyboard 5 and the mouse 6 are external equipment optionally connected to the computer, for example, via a connector provided in the computer main body.

The CPU 1 controls the whole information processing apparatus, executes programs stored in the system memory 2, and runs a BIOS stored in the BIOS-ROM 3 and described later. The programs stored in the system memory 2 include an operating system that manages resources for the apparatus, a device driver that drivingly controls peripheral equipment, utility programs, and application programs.

The system memory 2 is a storage medium such as a RAM which is used as a main storage device for the information processing apparatus. The system memory 2 stores the various programs executed by the CPU 1 and various data used in these programs. On the other hand, the BIOS-ROM 3 is a storage device that exclusively stored the BIOS and that is composed of a rewritable EEPROM. The BIOS, stored in the BIOS-ROM 3, has a POST processing unit 31 that checks and initializes various devices, activates the operating system, and performs other operations when the information processing apparatus is powered on, and a keyboard interrupt service unit 32 that converts scan codes acquired from the keyboard controller 4 into key codes.

The keyboard controller 4 acts as an input side of a user interface provided by the information processing apparatus. The keyboard controller 4 has a function to transmit the contents of operations performed on the keyboard 5 and mouse 6, to the CPU 1. For example, when any of the keys on the keyboard 5 is input, the keyboard controller 4 senses this input on the basis of the state of a plurality of signal lines from the keyboard 5. The keyboard controller 4 then generates and stores scan codes corresponding to the key in a data register 41. At this time, the keyboard controller 4 supplies an interrupt signal to the CPU 1 to notify it that a user has performed a certain operation. Then, upon receiving this notification, the CPU 1 runs the keyboard interrupt service unit 32 of the BIOS-ROM 3. The keyboard interrupt service unit 32 acquires the scan codes stored in the data register 41 of the keyboard controller 4, via the system bus. The keyboard interrupt service unit 32 converts the scan codes acquired into key codes. The keyboard interrupt service unit 32 stores the key codes in a predetermined area of the system memory 2. That is, the key codes are delivered to the operating system.

The keyboard controller 4 is also provided with a monitored key specifying unit 42 and a specified key monitoring unit 43. In the information processing apparatus according to the present invention, the monitored key specifying unit 42 and the specified key monitoring unit 43 make it possible to determine wither or not a predetermined key on the keyboard 5 has been input, without using scan codes or key codes. This will be described below in detail.

The monitored key specifying unit 42 enables a specification to be accepted through a command transmitted via the system bus, the specification indicating which key on the keyboard 5 is to be monitored for input. Specifically, the monitored key specifying unit 42 enables software to execute the specification and notifies the specified key monitoring unit 43 of the specified key. A plurality of keys can be specified at a time. On the other hand, the specified key monitoring unit 43 senses the input of the specified key on the basis of the state of the plurality of signal lines from the keyboard 5. The specified key monitoring unit 43 then stores the results of the monitoring in a register 431 as key input information. The key input information is data of at least n bits if the number of keys that can be accepted by the monitored key specifying unit 42 is n. Whether or not a key has been input is expressed by turning on or off the corresponding bit.

As previously described, the POST processing unit 31 of the BIOS checks and initializes various devices, activates the operating system, and performs other operations when the information processing apparatus is powered on. When a predetermined key input is provided after the power-on and before the operating system is activated, the POST processing unit 31 provides the user with an interface used to update environmental settings for the information processing apparatus. The POST processing unit 31 thus executes a process of updating the environmental settings for the information processing apparatus in accordance with instructions input via the interface.

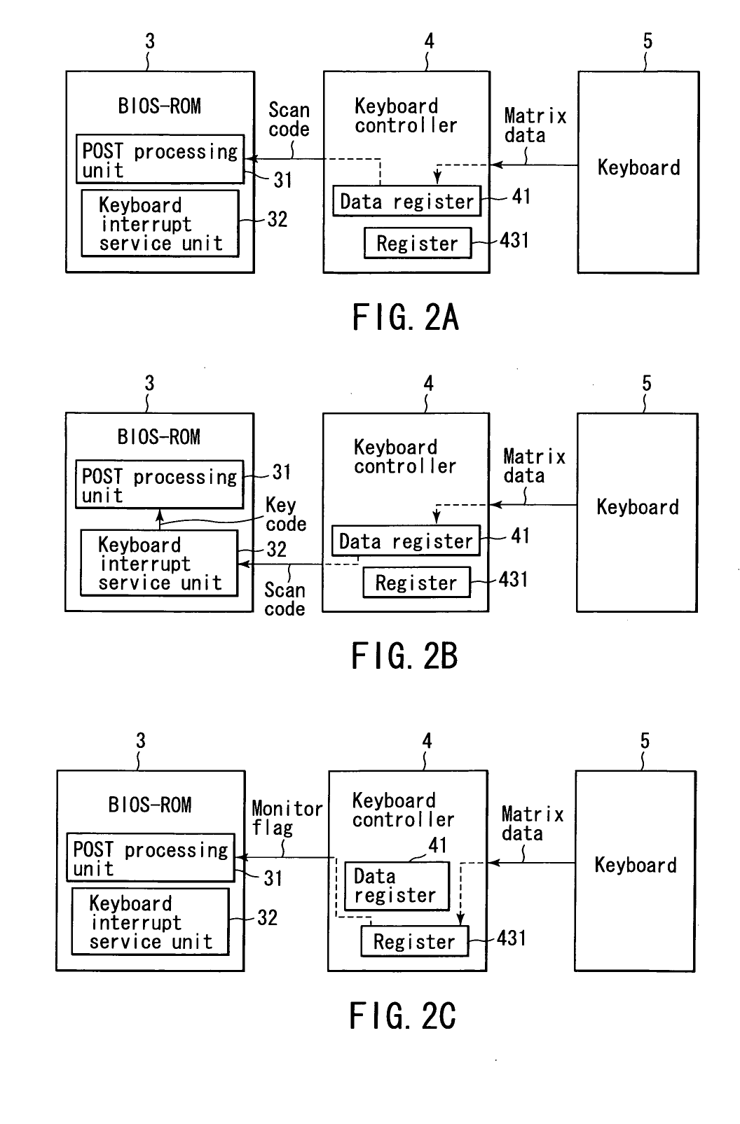

Specifically, the POST processing unit 31 of the BIOS must determine whether or not a predetermined key on the keyboard 5 has been input. In the prior art, this determination is made by acquiring scan codes from the keyboard controller 4 as shown in FIG. 2A or by the previously described keyboard interrupt service unit 32 by acquiring key codes into which the scan codes are converted, as shown in FIG. 2B. However, with this method, there are many cases in which the predetermined key input is not accepted by the BIOS and becomes useless, as already described. Furthermore, depending on when the keyboard interrupt service unit 32 starts operation, incorrect key codes may be generated at the time of the start, as already described. Thus, the information processing apparatus according to the present invention is provided with the previously described monitored key specifying unit 42 and specified key monitoring unit 43 to enable this determination without using scan codes or key codes.

More specifically, after being activated upon power-on, the POST processing unit 31 of the BIOS first notifies the monitored key specifying unit 42 of the keyboard controller 4 of a predetermined key for which the POST processing unit 31 is to determine whether or not the key has been input. Moreover, the specified key monitoring unit 43 of the keyboard controller 4 monitors input of this key on the basis of the state of the plurality of signal lines from the keyboard 5 (FIGS. 2A to 2C illustrate information obtained from the state of the plurality of signal lines, as matrix data). The specified key monitoring unit 43 then stores the results of the monitoring in the register 431. The specified key monitoring unit 43 can successfully monitor the key input and store the key input information even if the key controller 4 cannot communicate scan codes to the BIOS. Therefore, by acquiring the key input information stored in the register 431 (FIGS. 2A to 2C illustrate the key input information as monitor flags), the POST processing unit 31 can reliably determine whether or not the key has been input.

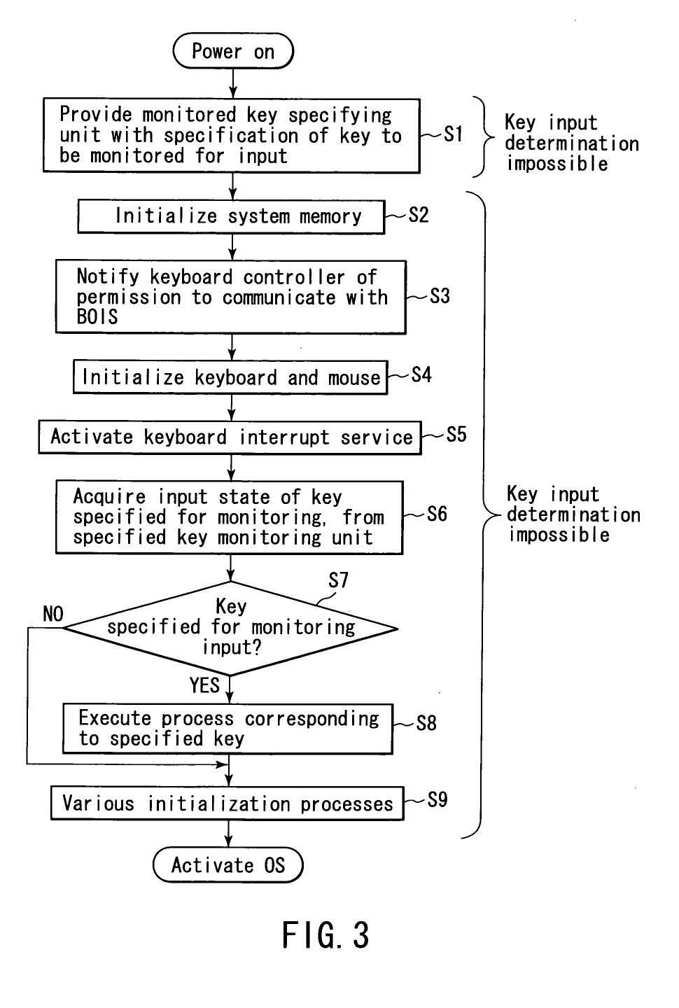

FIG. 3 is a flowchart showing the flow of the POST process executed by the POST processing unit 31.

The POST processing unit 31 first provides the monitored key specifying unit 42 of the keyboard controller 4 with the specification of the key to be monitored for input (step S1). If the key is input before this specification, the determination is impossible. However, the time from the power-on of the information processing apparatus till the specification is so short that the process is not substantially affected.

After finishing the specification, the POST processing unit 31 initializes the system memory 2 (step S2). Subsequently, the BIOS processing unit 31 notifies the keyboard controller 4 that it is permitted to communicate with the BIOS (step S3). At step S3, the keyboard controller 4 is permitted to make communication using the data register 41. At step S1, the specification of a key can be provided to the monitored key specifying unit 42 even before the keyboard controller 4 is notified of the permission to communicate.

After enabling the keyboard controller 4 to communicate with the BIOS, the POST processing unit 31 initializes the keyboard 5 and the mouse 6 (step S4). Once the keyboard 5 and the mouse 6 have been initialized, the POST processing unit 31 is ready to receive scan codes from the keyboard controller 4. The state of the POST processing unit 31 shifts to the one in which the keyboard interrupt service unit 32 can be run. Moreover, once the scan codes are stored in the data register 41 of the keyboard controller 4, the POST processing unit 31 activates the keyboard interrupt service unit 32, which converts the scan codes into key codes (step S5). The keyboard interrupt service unit 32 is activated to provide for subsequent utilization. In this case, the key codes are not acquired via the keyboard interrupt service unit 32.

Then, the POST processing unit 31 acquires the key input information stored in the register 431, from the specified key monitoring unit 43. The POST processing unit 31 then acquires the state of the key the specification of which was provided to the monitored key specifying unit 42 at step S1 (step S6). If the key input information acquired is indicative of the input of the specified key (Yes at step S7), the POST processing unit 31 executes a process corresponding to the specified key, for example, changes the environmental settings for the information processing apparatus (step S8).

After finishing the process corresponding to the key or if the key has not been input (NO at step S7), the POST processing unit 31 executes various initialization processes (step S9). The POST processing unit 31 then activates the operating system to end the process.

As described above, the information processing apparatus is provided with the monitored key specifying unit 42 that accepts, through the command transmitted via the system bus, the specification as to which key on the keyboard 5 is to be monitored for input, and the specified key monitoring unit 43 that senses the input of the specified key on the basis of the state of the plurality of signal lines from the keyboard 5 and that stores the results of the monitoring in the register 431 as key input information. The information processing apparatus can thus determine whether or not a predetermined key on the keyboard 5 has been input, without using scan codes or key codes. This makes it possible to prevent generation of incorrect key codes and eliminates almost all the cases in which the predetermined key input cannot be accepted.

Furthermore, the specified key monitoring unit 43 monitors the input of the key specified by the monitored key specifying unit 42 on the basis of the state of the plurality of signal lines from the keyboard 5. Consequently, special keys, which do not cause, when solely input, the keyboard controller to generate scan codes, can be used to, for example, activate certain functions.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. An information processing apparatus having a keyboard, comprising:
a specifying unit configured to specify an arbitrary key of the keyboard as a key for which it is determined whether or not the key has been input; and
a determining unit configured to determine, upon sensing a signal generated by operating the key specified by the specifying unit, that the specified key has been input.

2. The information processing apparatus according to claim 1, further comprising a register which stores information generated on the basis of the generated signal and indicating whether or not the specified key has been input,
wherein the determining unit determines whether or not the specified key has been input based on the information stored in the register.

3. The information processing apparatus according to claim 1, wherein the specifying unit is provided in a keyboard controller which communicates a key input from the keyboard to a CPU.

4. The information processing apparatus according to claim 1, further comprising a Basic Input/Output System (BIOS) which determines whether or not the key has been input based on the information stored in the register.

5. The information processing apparatus according to claim 1, wherein the specifying unit can specify a plurality of keys for which it is determined whether or not the key has been input, and
the determining unit determines whether or not each of the plurality of keys specified by the specifying means has been input.

6. The information processing apparatus according to claim 1, wherein the specifying unit can specify, as monitored targets, special keys which do not cause scan codes to be output when solely input.

7. A keyboard controller comprising:
a specifying unit configured to specify an arbitrary key of the keyboard as a key for which it is determined whether or not the key has been input; and
a register which stores information generated on the basis of a signal generated by operating the key specified by the specifying unit, the information indicating whether or not the specified key has been input.

8. A method of key input determination comprising:
specifying an arbitrary key of the keyboard as a key for which it is determined whether or not the key has been input; and
determining that the specified key has been input, if a signal is sensed which is generated by operating the key specified by the specifying.
